(19) United States
(12) Patent Application Publication
(10) Pub. No.: US 2010/0193506 A1
(43) Pub. Date: Aug. 5, 2010

(54) LITZ WIRE COIL

(75) Inventors: Masahiro Nagai, Tokyo (JP); Shirou Hasegawa, Tokyo (JP)

Correspondence Address: BACON & THOMAS, PLLC, 625 SLATERS LANE, FOURTH FLOOR, ALEXANDRIA, VA, 22314-1176, US

(73) Assignee: SWCC SHOWA DEVICE TECHNOLOGY, Tokyo (JP)

(21) Appl. No.: 12/665,165

(22) PCT Filed: Jul. 16, 2008
(86) PCT No.: PCT/JP2008/001906

§ 371 Date: Dec. 17, 2009

(30) Foreign Application Priority Data
Jul. 23, 2007 (JP) 2007-190516

(51) Int. Cl. H05B 6/36

(52) U.S. Cl. 219/672

(57) ABSTRACT

A litz wire coil is formed of two litz wires, each having a number of single wires equal to one half of a predetermined number of single wires and each stranded collectively in mutually reverse directions and wound in parallel. The two litz wires are shaped into a coil and then pressed into a predetermined shape by means of a die. Since the number of single wires within each of two litz wires is set equal to one half of a predetermined number, electrical resistance substantially equal to that of a single litz wire coil is attained without increasing the single wire diameter and without thickening the insulating film on the individual wires. Since two litz wires are collectively stranded in mutually reverse directions, risk of cross-cutting the single wires upon pressing is eliminated,

### TECHNICAL FIELD

This invention relates to a litz wire coil which is used for such as heating equipment adapting an induction heating method.

### BACKGROUND ART

Heretofore, a litz wire coil which can be used for such as induction heating is known (for example, refer to patent document No. 1). As for the coil which is used for electromagnetic induction heating, the usage in high frequency is demanded. As for the electric wire which is used for the high frequency coil, if the total of the sectional area is equal, a plurality of wires (for example, bunched wire) are advantageous than the single wire. As the litz wire, it is more advantageous that the wire rod which has fine single wire diameter and much single wire number is used, and that the wire rod bunching a plurality of litz wires further is used.

The coil having the high space factor is formed by high pressure by using the die after winding the wire, that is, is formed by press forming. Although it is preferable that the space factor is high as much as possible, there is a possibility that the overpressure gives the damage to the single wire of the litz wire. This damage links to the breaking of wire of the single wire and gives the great influence to the electrical property of the coil. Therefore, it is necessary to form by the condition which has the leeway to some extent.

In order to reduce the damage of the single wire, it is considered to enlarge (thicken) the single wire diameter, to thicken the insulating film of the single wire, or to set sparingly the condition of the pressure for forming.

Patent document No. 1: Japanese Patent Publication No. 2005-85560

### DISCLOSURE OF THE INVENTION

### Problem to be Solved by the Invention

In the conventional well-known technology, there were the following problems which have to be solved.

In the above-mentioned litz wire coil, in the case of enlarging the single wire diameter, when the coil is used in the high frequency area, the influence of the deterioration of the property appears. When the insulation film of the single wire is thickened, because the insulation material is used much obviously, it links to the increase of the cost of the litz wire production. When the condition of the pressure for forming is set sparingly, as the opposite effect, there is a difficult point that the targeted high space factor becomes insufficiently.

Besides, in the case of the coil which comprises one litz wire, there is a problem that the formed coil warps by the influence of the strand of the litz wire.

This invention was conducted to solve the above-mentioned problems And this invention aims to provide the litz wire coil who has no influence of the deterioration of the property even in high frequency area and which can obtain the sufficient high space factor inexpensively.

### Means for Solving the Problems

As for a litz wire coil which is the first feature of this invention for accomplishing above-mentioned purpose, two litz wires which are stranded collectively in reverse directions mutually are formed in a coil shape in parallel winding. According to the litz wire coil of this invention of such the first feature, because the two litz wires are stranded collectively in reverse directions mutually, the warpage of the formed coil can be reduced, and the warpage of the formed coil can be prevented.

As for the second feature of this invention, in the litz wire coil of the first feature, the two litz wires are formed in the coil shape in parallel winding, and subsequently, the two litz wires are formed to a predefined shape by press forming by a die. According to the litz wire coil of this invention of such the second feature, because the two litz wires are stranded collectively in reverse directions mutually, the contiguous single wires of the litz wires became parallel at the time of the press forming. Therefore, the generation of the cross cutting can be prevented.

As for the third feature of this invention, in the litz wire coil of the first feature or the second feature, the two litz wires have same single wire numbers respectively. According to the litz wire coil of this invention of such the third feature, because the single wire numbers of two litz wires are set equally to one half of the predefined number, the approximately equal electrical resistance compared with the litz wire coil which is formed usually by one litz wire can be set without enlarging the single wire diameter or without thickening the insulation film of the single wire.

As for the fourth feature of this invention, in the litz wire coil of any one of the first feature to the third feature, the two litz wires are lap winding in the radial direction in the state of the parallel arrangement, and are formed in the multilayer coil shape. Besides, as for the fifth feature of this invention, in the litz wire coil of any one of the first feature to the third feature, the two litz wires are wound in the state of being stacked vertically in the axial direction so that the strand directions of the single wires of the contiguous litz wires in the state of parallel arrangement became reverse directions mutually, and are formed in the coil shape. According to the litz wire coil of this invention of such the fourth feature and the fifth feature, even if the two litz wires are lap winding or are stacked vertically, because the two litz wires are stranded collectively in reverse directions mutually, and because the warpage of the formed coil is reduced and the warpage of the formed coil is prevented, the multilayer coil which has higher space factor can be obtained even if the cross-sectional shape of the litz wire is any of the circle or the square

Besides, as for the litz wire coil which is the sixth feature of this invention for accomplishing above-mentioned purpose, a plurality of litz wires are formed in the coil shape in parallel winding, and the contiguous litz wires are stranded collectively in reverse directions mutually. According to the litz wire coil of this invention of such the sixth feature, as well as the litz wire coil of this invention of the first feature, because the contiguous litz wires are stranded collectively in reverse directions mutually, the warpage of the formed coil can be reduced, and the warpage of the fanned coil can be prevented.

### Effect of the Invention

According to the litz wire coil of this invention, there is no influence of the deterioration of the property even in high frequency area and the sufficient high space factor can be obtained inexpensively.

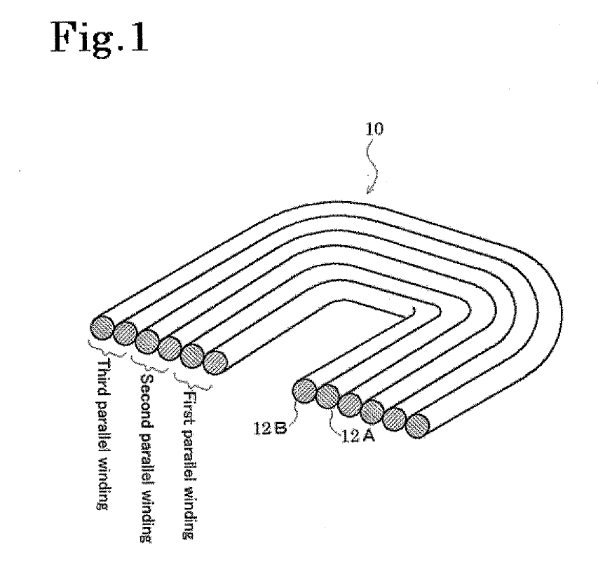

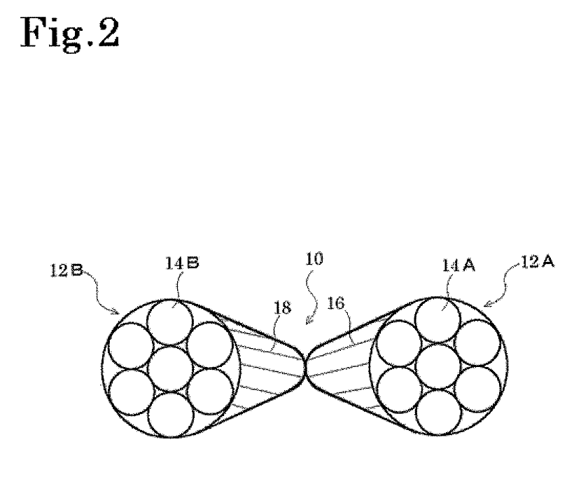

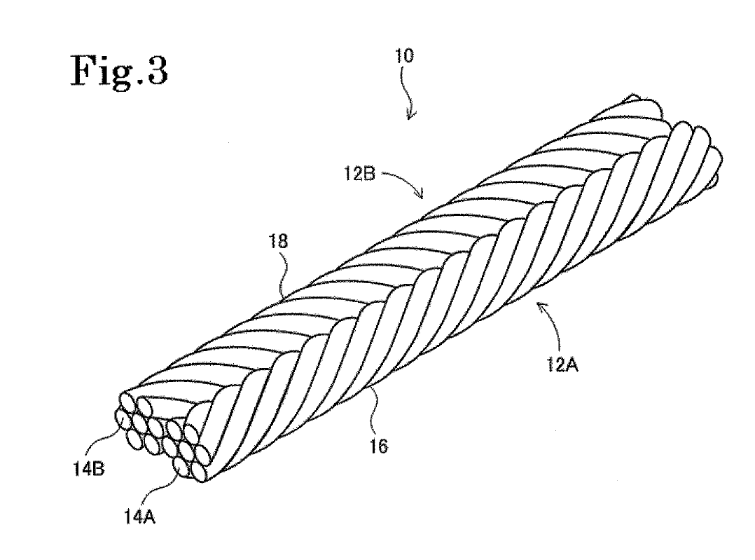

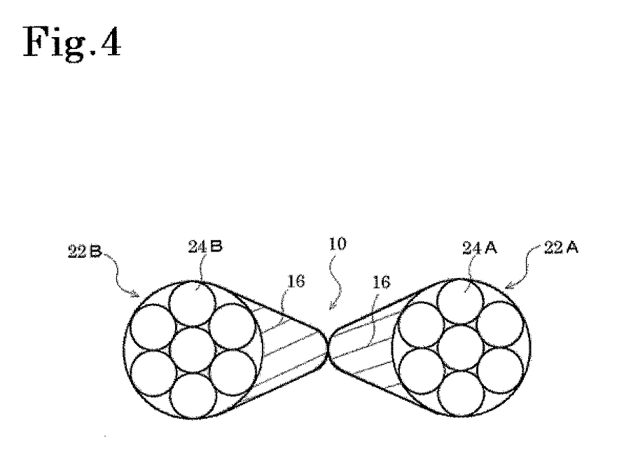

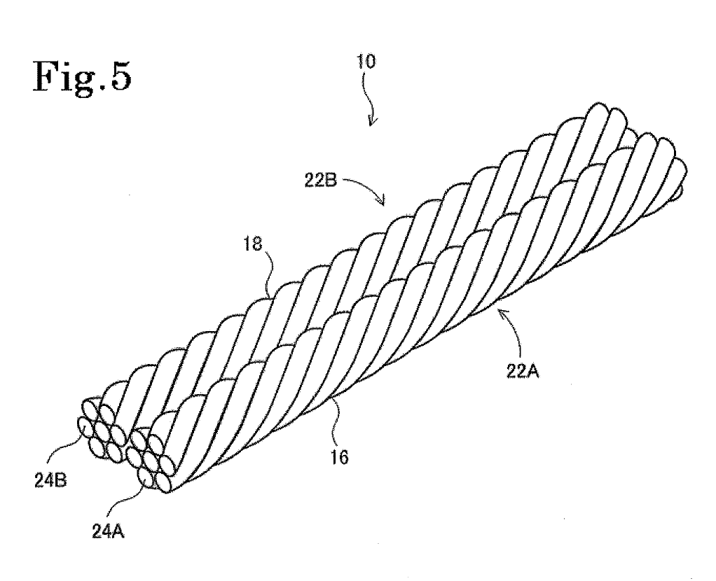

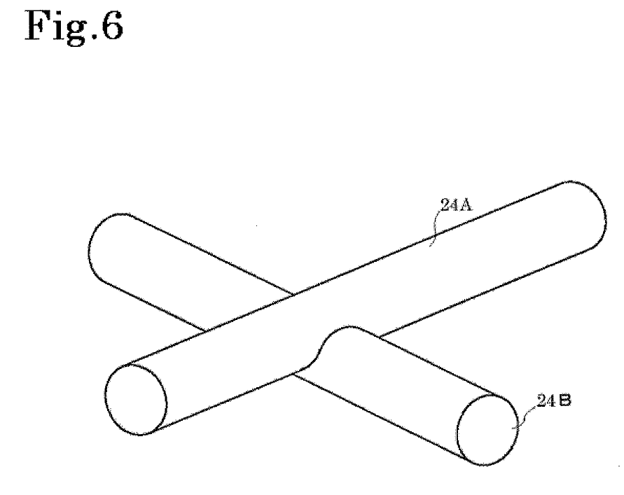

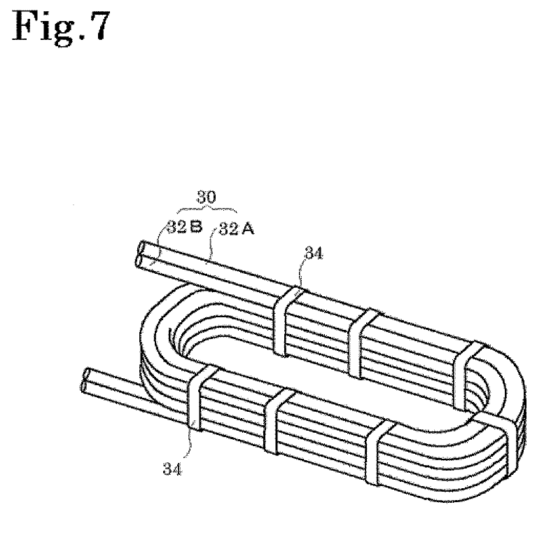

### BRIEF DESCRIPTION OF THE FIGURES

[FIG. 1] A perspective view showing a part of the litz wire coil 10 of the example 1.

[FIG. 2] A schematic view showing the two litz wires of the litz wire coil 10.

[FIG. 3] A perspective view showing the two litz wires of the litz wire coil 10.

[FIG. 4] A schematic view showing the two litz wires of other litz wire coil in the example 1.

[FIG. 5] A perspective view showing the two litz wires of other litz wire coil in the example 1.

[FIG. 6] A enlarged schematic view of the single wire of the litz wire which is shown in FIG. 4 and FIG. 5.

[FIG. 7] A perspective view showing the litz wire coil 30 of the example 2.

### BEST MODE FOR CARRYING OUT THE INVENTION

Hereinafter, the embodiments of this invention are explained in detail every example. FIG. 1 is the perspective view showing a part of the litz wire coil 10 of the example 1. FIG. 2 is the schematic view showing the two litz wires of the litz wire coil 10. FIG. 3 is the perspective view showing the two litz wires of the litz wire coil 10. FIG. 4 is the schematic view showing the two litz wires of other litz wire coil in the example 1. FIG. 5 is the perspective view showing the two litz wires of other litz wire coil in the example 1. FIG. 6 is the enlarged schematic view of the single wire of the litz wire which is shown in FIG. 4 and FIG. 5. FIG. 7 is the perspective view showing the litz wire coil 30 of the example 2.

### Embodiment 1

As shown in FIG. 1, as for the litz wire coil 10 which is one mode of the embodiment of this invention, the two litz wires 12A and 12B which are stranded collectively in reverse directions mutually are formed in the coil shape in parallel winding. For example, as shown in FIG. 2 and FIG. 3, in the two litz wires 12A and 12B like this, the strand of the litz wire 12A is the right-handed strand 16 and the strand of the litz wire 12B is the left-handed strand 18, and these are stranded collectively in reverse directions mutually.

In this way, by composing the litz wire coil 10 by stranding the two litz wires collectively in reverse directions mutually, the warpage of the formed coil can be reduced and the warpage of the formed coil can be prevented. This is the reason that when the two litz wires 12A and 12B are stranded collectively in reverse directions mutually, because the contiguous single wires of the litz wires become parallel and the directions of the warpage become opposite directions, the directions of the warpage of the two litz wires 12A and 123 are canceled and the straightness becomes excellent. Therefore, because the improvement of the condition till the high forming pressure becomes possible by aligning the single wires in parallel, the high space factor can be obtained in the state of maintaining the high quality.

Besides, as shown in FIG. 4 and FIG. 5, as for the litz wire coil 10, when carrying out the press forming after stranding the two litz wires 22A and 228 collectively in same directions mutually, for example, as right-handed strand 16, and carrying out the parallel winding, as shown in FIG. 6, because the single wires 24A and 24B of the litz wires 22A and 22B cross partially, the phenomenon (cross cutting) of digging into is caused. Therefore, the insulation film of each single wire 24A and 24b is destroyed and the damage to the breaking of wire is caused. Consequently, the two litz wires 12A and 12B which are stranded collectively in reverse directions mutually are formed in the coil shape in parallel winding, and subsequently, carrying out the press forming by using well-known die to the predefined shape which corresponds to the aim of usage is preferable.

In this way, as for the litz wire coil 10, the two litz wires 12A and 12B are formed in the coil shape in parallel winding, and subsequently the press forming is carried out to the predefined shape by the die. Thereby, because the two litz wires 12A and 12B are stranded collectively in reverse directions mutually, the contiguous single wires of the litz wires become parallel at the time of the press forming. Therefore, the generation of the cross cutting can be prevented. Consequently, it is possible to reduce the damage of the single wire even if the press forming is carried out by high forming pressure for being able to achieve the high space factor of the coil.

Further, the single wire numbers of the two litz wires 12A and 12B of the litz wire coil 10 are same respectively. The single wire numbers of the two litz wires 12A and 12B are set equally to one half of the predefined number. That is, the single wire number (N) of the litz wire coil which is formed usually by one litz wire is set equally to one half (N/2). In this way, because the single wire numbers of the two litz wires 12A and 12B are set equally to one half of the predefined number, the warpage of the formed coil can be prevented. Further, because the approximately equal electrical resistance compared, with the litz wire coil which is formed usually by one litz wire can be set without enlarging the single wire diameter and without thickening the insulation film of the single wire, the influence of the deterioration of the property can be prevented when the coil is used in the high frequency area.

As shown in FIG. 1, the litz wire coil 10 which is composed in this way is formed in the multilayer coil shape that the two litz wires 12A and 12B are lap winding in the radial direction in the state of the parallel arrangement. Even if the two litz wires 12A and 12B are lap winding, because the two litz wires 12A and 123 are stranded collectively in reverse directions mutually, and because the warpage of the formed coil is reduced and the warpage of the formed coil is prevented, the multilayer coil which has higher space factor can be obtained even if the cross-sectional shape of the litz wire is any of the circle or the square In addition, as for the litz wire coil 10, the two litz wires 12A and 123 may be formed in the single layer coil shape in the state of the parallel arrangement.

### Embodiment 2

As shown in FIG. 7, as for the litz wire coil 30 which is other one mode of the embodiment of this invention, the two litz wires 32A and 323 are wound in the state of being stacked vertically in the axial direction so that the strand directions of the single wires of the contiguous litz wires in the state of parallel arrangement because reverse directions mutually, and are formed in the coil shape. Even if the two litz wires 32A and 323 are wound in the state of being stacked vertically, the two litz wires 32A and 323 are stranded collectively in reverse directions mutually, and the warpage of the formed coil is reduced and the warpage of the formed coil is prevented. Therefore, the multilayer coil which has higher space factor can be obtained even if the cross-sectional shape of the litz wire is any of the circle or the square.

Besides, the two litz wires 32A and 32B which are stranded collectively in reverse-directions mutually are wound in the state of being stacked vertically, and are formed in the coil shape, and subsequently, carrying out the press forming by using well-known die to the predefined shape which corresponds to the aim of usage is preferable.

In this way, as for the litz wire coil 30, the two litz wires 32A and 32B are parallel winding and are wound in the state of being stacked vertically, and are formed in the coil shape. Since then, the press forming is carried out in the predefined shape by the die. Thereby, because the two litz wires 32A and 32B are stranded collectively in reverse directions mutually, the contiguous single wires of the litz wires became parallel at the time of the press forming. Therefore, the generation of the cross cutting can be prevented. Consequently, it is possible to reduce the damage of the single wire even if the press forming is carried out by high forming pressure for being able to achieve the high space factor of the coil.

Further, the single wire numbers of the two litz wires 32A and 32B of the litz wire coil 30 are same respectively. When the single wire numbers of the two litz wires 32A and 32B are set equally to one half of the predefined number in this way, as well as the litz wire coil 10 of example 1, the warpage of the formed coil can be prevented. Besides, because the approximately equal electrical resistance compared with the litz wire coil which is formed usually by one litz wire can be set without enlarging the single wire diameter and without thickening the insulation film of the single wire, the influence of the deterioration of the property can be prevented when the coil is used in the high frequency area.

In addition, in the litz wire coil 30, although the figure is not indicated, as for the two litz wires 32A and 32B, in order to set the directions of the strand of the litz wires which is contiguous in the state of the parallel arrangement so as to become the reverse directions mutually, the two litz wires 32A and 32B are twisted so as to turn inside out whenever they are stacked vertically. Concretely, by twisting the two litz wires 32A and 32B in any one of the curved parts of two places of the litz wire coil 30, the litz wire 32A which is positioned at outside is positioned at inside, and the litz wire 32B which is positioned at inside is positioned at outside. By composing in this way, the litz wire coil which has higher space factor and is the type of stacking vertically can be obtained.

Besides, the whole shape of the litz wire coil 30 is fanned in the shape of hexahedron, and the holding tape 34 is bound at any place of the circumference. The holding tape 34 holds the litz wire coil 30 to the predefined coil shape temporarily or for long time, and it is preferable to have the heat-resistance and to be thin about the thickness. In this way, because the shape of the litz wire coil 30 can be maintained by binding the holding tape 34 at any place of the circumference of the litz wire coil 30, the change of the inductance value can be prevented.

In addition, in the abovementioned example 1 and example 2, although the two litz wires are parallel winding, as well as this, a plurality of litz wires may be formed in the coil shape in the parallel winding, and the above-described contiguous litz wires may be stranded collectively in reverse directions mutually.

In this way, by stranding the contiguous litz wires collectively in reverse directions mutually, the warpage of the formed coil can be reduced and the warpage of the formed coil can be prevented. Therefore, because the improvement of the condition till the high forming pressure becomes possible by aligning the single wires in parallel, the high space factor can be obtained in the state of maintaining the high quality.

1. A litz wire coil, comprising:
two litz wires formed in a coil shape with parallel winding, and
the two litz wires being stranded collectively in mutually reverse directions.

2. The litz wire coil according to claim 1,
wherein said two litz wires are formed in said coil shape in parallel winding, and subsequently, the two litz wires are formed to a predefined shape by press forming by a die.

3. The litz wire coil according to claim 2,
wherein said two litz wires each have the same number of single wires.

4. The litz wire coil according to claim 3,
wherein said two litz wires are lap wound in the radial direction to form a multilayer coil shape.

5. The litz wire coil according to claim 3,
wherein said two litz wires are wound stacked vertically in the axial direction so that the strand directions of the single wires of the contiguous litz wires with the parallel winding, are mutually reverse directions.

6. A litz wire, comprising:
a plurality of litz wires wound in parallel, and formed in a coil shape, and
the contiguous litz wires being stranded collectively in mutually reverse directions.

7. The litz wire coil according to claim 1,
wherein said two litz wires each have the same number of single wires.

8. The litz wire coil according to claim 7,
wherein said two litz wires are lap wound in the radial direction to form a multilayer coil shape.

9. The litz wire coil according to claim 1,
wherein said two litz wires are lap wound in the radial direction to form a multilayer coil shape.

10. The litz wire coil according to claim 2,
wherein said two litz wires are lap wound in the radial direction to form a multilayer coil shape.

11. The litz wire coil according to claim 1,
wherein said two litz wires are wound stacked vertically in the axial direction so that the strand directions, of the single wires of the contiguous litz wires with the parallel winding, are mutually reverse directions.

12. The litz wire coil according to claim 2,
wherein said two litz wires are wound stacked vertically in the axial direction so that the strand directions, of the single wires of the contiguous litz wires with the parallel winding, are mutually reverse directions.

13. The litz wire coil according to claim 7,
wherein said two litz wires are wound stacked vertically in the axial direction so that the strand directions, of the single wires of the contiguous litz wires with the parallel winding, are mutually reverse directions.
